(19) United States
(12) Patent Application Publication
(10) Pub. No.: US 2005/0203866 A1
(43) Pub. Date: Sep. 15, 2005

(54) Method and system for computerized creation, maintenance and querying of Internet based multi-attribute dynamic object rating system

(76) Inventors: Mohamed Daud, Selangor (MY); Mohd. Zohadie Bardaie, Selangor (MY); Husaini Omar, Selangor (MY)

Correspondence Address: CHAPIN & HUANG L.L.C.;WESTBOROUGH OFFICE PARK, 1700 WEST PARK DRIVE, WESTBOROUGH, MA, 01581, US

(21) Appl. No.: 11/054,743

(22) Filed: Feb. 10, 2005

(30) Foreign Application Priority Data
Mar. 15, 2004 (MY) PI 20040901

(51) Int. Cl. G06F 17/30; G06F 7/00

(52) U.S. Cl. 707/1; 707/7

(57) ABSTRACT

The present invention relates to a method and system for computerized creation, maintenance and querying of an Internet-based multi-attribute dynamic object rating system. An Internet-based ecotourism-site rating expert system was developed using this multi-attribute dynamic object method. The rating system takes into consideration the many types of ecotourism categories, facilities and activities available at an ecotorism sites. Various levels of compliance such as site safety, health, environmental and quality of services will determine the rating of the site. Group of parties may use this online system to rate an object, for example ecotourism site. Such parties may include visitors, site operator or moderator, and ecotourism auditors. The ratings produced using this system are very transparent because all the scores given by the three groups of people can be made available to the public. The rating system includes a means to create multi-attributes of the system, a means to use the multi-attributes and a means for the maintenance of the multi-attributes.

### 1. TECHNICAL FIELD OF THE INVENTION

The present invention generally relates to a system for rating an object and more particularly to a system for computerized creation, maintenance and querying of an Internet-based multi-attribute dynamic object especially for the rating system. The present invention also relates to a method of the same.

### 2. BACKGROUND OF THE INVENTION

Tourism is well documented as the world's largest industry, contributing significantly to many national and regional economies. It is a known fact that the travel and tourism industry is a heavy user of the electronic connectors around the globe. Generally, information technology provides the information backbone that facilitates tourism. Study has shows that the linkage that supports the two of the largest and fastest growing industries in the world today; tourism and information technology is growing. In general, the scope of the tourism industry, including ecotourism is very wide, their operational environment is very unstable and sensitive, thus requires very high degree of electronic communication.

In this project, an expert system with an Internet capability for rating of ecotourism sites was developed. Knowledge from domain experts, and results of field survey were incorporated into the expert system. Besides the environmental performance, other factors such as safety and health issues were also incorporated into the rating system in order to have a more accurate and comprehensive reflection of the actual requirements of the ecotourism sites. To implement such expert system, a digital computing network with Internet capability was developed by the inventors. Throughout the description, an object within the context of the present invention may include product and/or services.

### 3. SUMMARY OF THE INVENTION

The multi-attributes dynamic object rating system of the present invention will allow various parties to rate a product or services with the various rating entities on-line. This rating system is developed to be flexible; it can accommodate multi-attributes to the rating entities, accommodate relative weightage to each attribute and accommodate different scoring guideline for each of the attribute. The accumulative scores from all the attributes determine the final grade. The Internet-based rating system also can be used to modify any of the variables mentioned. This invention has been tested on the Internet Based Rating System for Malaysian ecotourism. The ecotourism label to be developed for Malaysia must take into accounts many variability that are associated with ecotourism industry. In-depth knowledge about the level of importance of issues related to the variability is needed before the proposed ecolabel could be developed.

In general, nine attributes of ecotourism definition have been used as the basis in determining if a tourism site could be characterized as an ecotourism site. According to domain experts, a tourist attraction has to satisfy the ecotourism definition before the site could be categorise as an ecotourism site. Once the site had passed the definition requirement, the ecotourism definition score would be added to the scores of previous four rating attributes. The multi-attribute system analysis is a correlation between the variables and the factors. Pure variables have a loading of 0.5 or greater on only one factor. Complex variables may have high loadings on more than one factor and they make interpretation of the output difficult. Rotation may therefore be necessary.

A prospective visitor to the site has the right to know in advance before they decide to visit the place. The Internet-based ecotourism site rating expert system of the present invention provides rating of an ecotourism site based on the definition of an ecotourism site. This rating system takes into consideration many types of ecotourism categories, facilities and activities available to ecotourism sites in Malaysia, or any other part of the wold. Easily accessibility through Internet, transparency of the rating, accountability of a person who use the system, and the incorporation of knowledge from domain experts and field data are the strength of this rating system. New knowledge and information could easily be incorporated into the system.

### 4. BRIEF DESCRIPTION OF THE DRAWINGS

The embodiments of the invention will now be described, by way of example only, with reference to the accompanying figures in which:

FIG. 1 shows a flow chart for the creation of multi-attributes Internet-based rating system according to the present invention.

FIG. 2 shows a flow chart of the usage of multi-attributes Internet-based rating system according to the present invention.

FIG. 3 shows a flow chart for querying of multi-attributes Internet-based rating system according to the present invention.

FIG. 4 shows a flow chart for the maintenance of multi-attributes Internet-based rating system according to the present invention.

### 5. DETAILED DESCRIPTION OF THE DRAWINGS

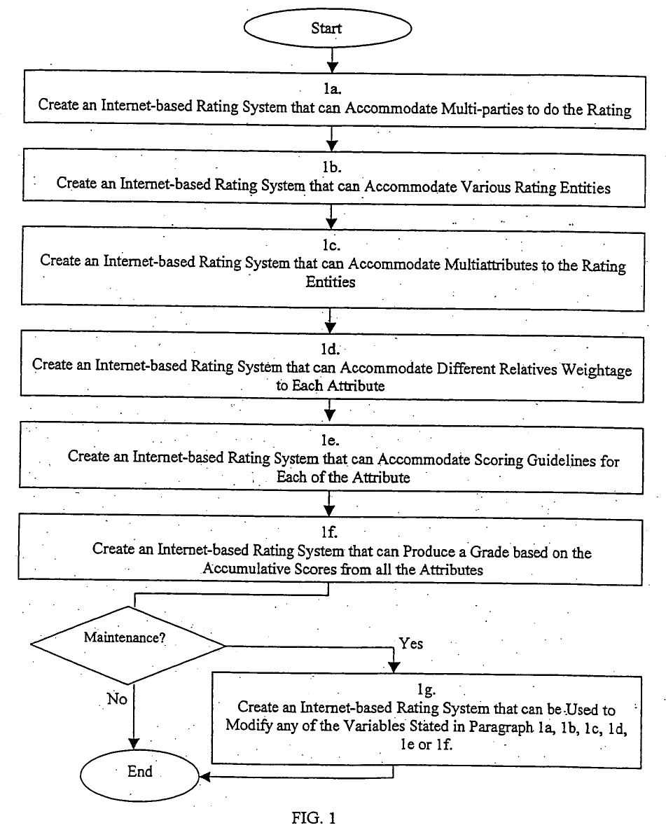

Referring now to drawings especially to FIG. 1, there is shown the flowchart of the preferred method for the creation of multi-attributes Internet-based rating system according to the present invention. This method contains seven levels of features in order to develop the multi-attributes Internet-based rating system, which comprises of:

1a. Create an Internet-based rating system that can accommodate multi-parties to do the rating; i.e. more than one parties can use this system online to rate a product or service.

1b. Create an Internet-based rating system that can accommodate various rating entities; i.e. more than one entity on a different category can be used.

1c. Create an Internet-based rating system that can accommodate multi-attributes to the rating entities; i.e. each entity can have different attributes.

1d. Create an Internet-based rating system that can accommodate different relative weightage to each attribute; i.e. each attribute will have different relative weightage.

1e Create an Internet-based rating system that can accommodate scoring guidelines for each of the attribute; i.e. each attribute will have a scoring guideline.

1f. Create an Internet-based rating system that can produce a grade based on the accumulative scores from all the attributes; i.e. the grade, which is the result will be based on the accumulative scores from all the attributes.

1g. Create an Internet-based rating system that can be used to modify any of the variables stated in paragraph 1a, 1b, 1c, 1d or 1e; i.e. all the variables stated can be modified.

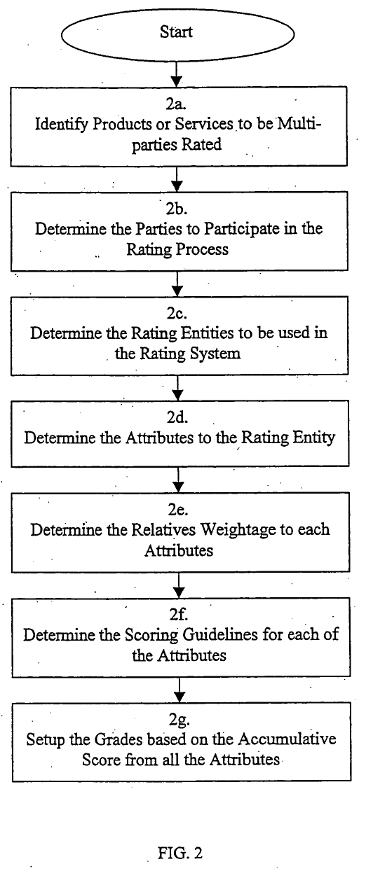

Referring now to FIG. 2 where the flowchart of the usage of multi-attributes Internet-based rating system of the present invention is shown. The usage of this system can be comprised into seven steps:

2a. Identify products or services to be multi-parties rated. For example, hotels, ecotourism sites or public transport.

2b. Determine the parties to participate in the rating process. For example, three parties can rate an ecotourism site; i.e. 1. Visitors 2. Moderators, and 3. Auditors.

2c. Determined the rating entities to be used in the rating system. For example, the entities for the ecotourism site is 1. Safety compliance, 2. Health compliance, 3. Environmental compliance, and 4. Quality of service.

2d. Determine the attributes to the rating entity. For example, the attributes for Safety Compliance entity is 1. Has complete Emergency Response Plan (ERP), 2. Guidelines on safety observed and 3. Surrounding of the site is safe.

2e. Determine the relatives weightage to each attribute. For example, the relative weightage of the Safety compliance, Health compliance, Environmental compliance, and Quality of service is 25.0, 25.8, 24.9, and 24.3 respectively.

2f. Determine the scoring guidelines for each of the attribute. For example, a score of +100, 0, or −100 is given if the ecotourism site is totally comply, acceptably comply, or fail to comply to a safety standard respectively.

2g. Setup the grades based on the accumulative score from all the attributes. Example, if the total score is higher than 80%, 70-79, 60-69, 50-59, or 40-49 the grade will be ECO-5, ECO-4, ECO-3, ECO-2, and ECO-1 respectively.

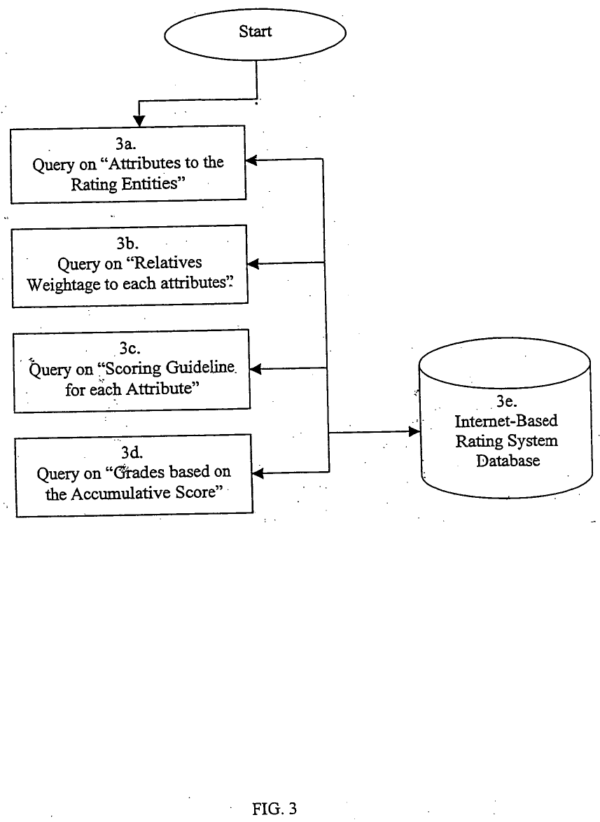

Referring now to FIG. 3, the querying process of the multi-attributes Internet-based rating system according to the present invention is shown. The querying process in this rating system can be comprised into five components:

3a. Attributes to the rating entities; i.e. all the process related to the attributes for the rating entities will be extracted from the database.

3b. Relatives weightage to each attributes; i.e. all the process related to the relatives weightage to each attribute will be extracted from the database.

3c. Scoring guideline for each attribute; i.e. all the process related to the scoring guideline will be extracted from the database.

3d. Grades based on the accumulative score; i.e. the accumulative score will be referred to the grades in the database, where the final result will be shown as a grade.

3e. Internet-based rating system database; i.e. all the data about the rating attributes, relative weightage, scores and grades will be recorded in the database together with the relevant information. All the process for this rating system will extract the data and the information from the database.

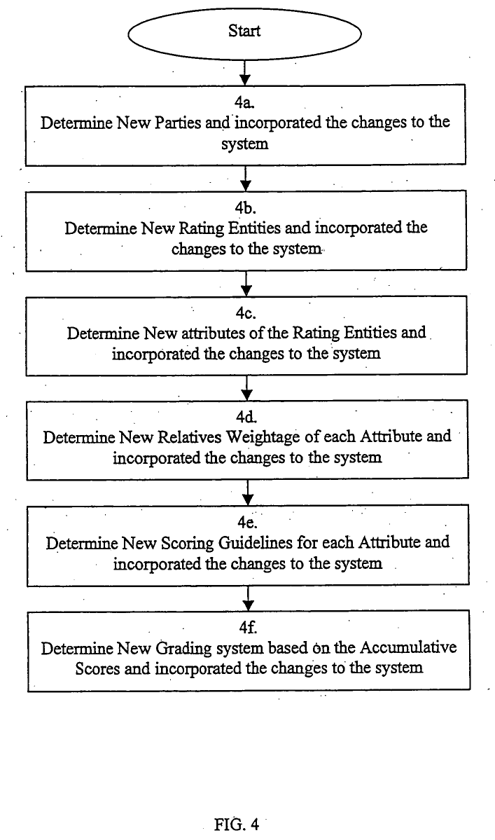

FIG. 4 shows the maintenance of multi-attributes Internet-based rating system of the present invention, in which:

4a. Determine new parties and incorporated the changes to the system; i.e. new parties can be determined and the existing parties can be modified or change.

4b. Determine new rating entities and incorporated the changes to the system; i.e. new rating entities can be determined and the existing rating entities can be modified or change.

4c. Determine new attributes of the rating entities and incorporated the changes to the system; i.e. new attributes to the rating entities can be determined and the existing attributes to the rating entities can be modified or change.

4d. Determine new relatives weightage of each attribute and incorporated the changes to the system; i.e. new relatives weightage to each attribute can be determined and the existing relative weightage to each attribute can be modified or change.

4e. Determine new scoring guidelines for each attribute and incorporated the changes to the system; i.e. new scoring guideline for each attribute can be determined and the existing scoring guideline for each attribute can be determined and the existing scoring guideline for each attribute can be modified or change.

4f. Determine new grading system based on the accumulative scores and incorporated the changes to the system; i.e. new grades based on the score points can be determined and the existing grades based on the score points can be modified or change.

While the preferred embodiments of the present invention have been described, it should be understood that various changes, adaptations and modifications may be made thereto. It should be understood, therefore, that the invention is not limited to details of the illustrated invention shown in the figures and that variations in such minor details will be apparent to one skilled in the art.

1. A digital computing network for use in association with an Internet-based rating system comprising:—
a host means having at least a host processor;
a connection means connecting said host means to a plurality of parties;
characterized in that:—
said rating system includes;
a means to create multi-attributes for said rating system;
a means for using said multi-attributes; and
a means for the maintenance of said multi-attributes.

2. A digital computing network for use in association with an Internet-based rating system as claimed in claim 1, further characterized in that said multi-attributes creation means is adapted to accommodate said parties, allows various rating entities to be incorporated into said rating system accommodates multi-attributes to said various rating entities, accommodates relative weightage to each of the attribute, accomodates scoring guidelines for each of the attribute and assigning a grade to said object based on accumulative scores from all of the attributes.

3. A digital computing network for use in association with an Internet-based rating system as claimed in claim 2, further characterized in that any of said components within said multi-attributes creation means is subject to change.

4. A digital computing network for use in association with an Internet-based rating system as claimed in claim 1, further characterized in that said means for using said multi-attributes includes identifying an object to be rated, determining the parties to participate in the rating of said object, determining the rating entities for said object, determining the attributes to each of the rating entity, determining the relative weightage to each attribute, determining the scoring guidelines for each of the attribute and assigning a grade associated with said object based on the accumulative score from all of the attributes.

5. A digital computing network for use in association with an Internet-based rating system as claimed in claim 1, further characterized in that said means for the maintenance of said attributes includes determining new parties, determining new rating entities, determining new attributes of said rating entities, determining new relative weightage of each of said attribute, determining new scoring guidelines for each of said attribute, assigning a new grading for said object based on the accumulative scores from all of said attributes, and incorporating any or all of the new determined components of said maintenance means into said rating system.

6. A method to provide an Internet-based object rating system in a digital computing network, characterized in that said method comprises the steps of:—
creating multi-attributes associated with said rating system;
using said multi-attributes to assign a grade associated with said rated object; and
maintaining the multi-attributes associated with said rating system.

7. A method to provide an Internet-based rating system in a digital computing network as claimed in claim 6, further characterized in that said creation of multi-attributes associated with said rating system includes the steps of:—
accommodating a plurality of rating parties;
allowing various rating entities to be incorporated into said rating system;
accommodating multi-attributes to said various rating entities;
accommodating relative weightage to each of the attribute;
accommodating scoring guidelines for each of the attribute; and
assigning a grade associated with said object based on the accumulative scores from all of the attributes.

8. A method to provide an Internet-based rating system in a digital computing network as claimed in claim 7, further characterized in that any of said steps within multi-attributes creation means is subject to change.

9. A method to provide an Internet-based rating system in a digital computing network as claimed in claim 6, further characterized in that said use of said rating system includes the steps of:—
identifying an object to be rated;
determining the parties to participate in the rating of said object;
determining the rating entities for said object;
determining the attributes to each of the rating entities;
determining the relative weightage to each attribute;
determining the scoring guidelines for each of the attribute; and
assigning a grade associated with said object based on the accumulative score from all of the attributes.

10. A method to provide an Internet-based rating system in a digital computing network as claimed in claim 6, further characterized in that said maintaining of said attributes includes the steps of:—
determining new parties to rate said object;
determining new rating entities;
determining new attributes of said rating entities;
determining new relative weightage of each of said attribute;
determining new scoring guidelines for each of said attribute;
assigning new grading for said object based on the accumulative scores from all of the attributes; and incorporating any or all of the new determined components of the maintaining step into said rating system.
